(19) United States
(12) Patent Application Publication
(10) Pub. No.: US 2023/0094992 A1
(43) Pub. Date: Mar. 30, 2023

(54) METHOD, ELECTRONIC DEVICE, AND STORAGE MEDIUM FOR GENERATING WIRELESS SIGNAL FINGERPRINT DATABASE

(71) Applicant: Beijing Baidu Netcom Science Technology Co., LTD., Beijing (CN)

(72) Inventors: Chuanming ZHANG, Beijing (CN); Min LIU, Beijing (CN); Zhi WANG, Beijing (CN); Hailu JIA, Beijing (CN)

(21) Appl. No.: 18/076,229

(22) Filed: Dec. 6, 2022

(30) Foreign Application Priority Data
Dec. 9, 2021 (CN) 202111501250.X

(51) Int. Cl. G01S 5/02

(52) U.S. Cl. CPC G01S 5/02522; G01S 5/02524; G01S 5/02527; H04W 84/12

(57) ABSTRACT

A method for generating a wireless signal fingerprint database includes: obtaining an initial atmospheric pressure value, in which the initial atmospheric pressure value is an atmospheric pressure value collected when a terminal enters indoors; obtaining periodically a current wireless signal fingerprint and a current atmospheric pressure value collected by the terminal; and determining a floor corresponding to the current wireless signal fingerprint based on the initial atmospheric pressure value and the current atmospheric pressure value, to obtain the wireless signal fingerprint database.

### CROSS-REFERENCE TO RELATED APPLICATION

This application claims priority to Chinese Patent Application No. 202111501250.X, filed on Dec. 9, 2021, the entire content of which is incorporated herein by reference.

### FIELD

The disclosure relates to the field of data processing technologies, and more particularly, to the field of indoor positioning technologies.

### BACKGROUND

A wireless fidelity (Wi-Fi) fingerprint database includes Wi-Fi fingerprints collected from indoor locations, which can be used for an indoor positioning of a terminal.

### SUMMARY

A method for generating a wireless signal fingerprint database is provided, which includes: obtaining an initial atmospheric pressure value, in which the initial atmospheric pressure value is an atmospheric pressure value collected when a terminal enters indoors; obtaining periodically a current wireless signal fingerprint and a current atmospheric pressure value collected by the terminal; and determining a floor corresponding to the current wireless signal fingerprint based on the initial atmospheric pressure value and the current atmospheric pressure value, to obtain the wireless signal fingerprint database.

An electronic device is provided, which includes: at least one processor; and a memory communicatively coupled to the at least one processor; in which the memory is configured to store instructions executable by the at least one processor, and the at least one processor is configured to execute the instructions to perform any method as described above.

A non-transitory computer-readable storage medium storing computer instructions is provided. The computer instructions are configured to cause a computer to perform any method as described above.

It should be understood that the content described in this section is not intended to identify key or important features of embodiments of the disclosure, nor is it intended to limit the scope of the disclosure. Additional features of the disclosure will be easily understood based on the following description.

### BRIEF DESCRIPTION OF THE DRAWINGS

The drawings are used to better understand solutions and do not constitute a limitation to the disclosure, in which:

FIG. 1 is a flowchart of a method for generating a wireless signal fingerprint database, according to some embodiments of the disclosure.

FIG. 2 is a flowchart of a method for correcting a wireless signal fingerprint database, according to some embodiments of the disclosure.

FIG. 3 is a flowchart of a method for generating a wireless signal fingerprint database, according to some embodiments of the disclosure.

FIG. 4 is a schematic diagram of an apparatus for generating a wireless signal fingerprint database, according to some embodiments of the disclosure.

FIG. 5 is a block diagram of an electronic device for implementing a method for generating a wireless signal fingerprint database, according to some embodiments of the disclosure.

### DETAILED DESCRIPTION

The following describes embodiments of the disclosure with reference to the drawings, which includes various details of embodiments of the disclosure to facilitate understanding and shall be considered merely exemplary. Accordingly, those skilled in the art may recognize that various changes and modifications to embodiments described herein may not depart from the scope and spirit of the disclosure. For clarity and conciseness, descriptions of well-known functions and structures are omitted in the following description.

For indoor positioning, it is important to position a floor located by a terminal. Different floors in a building correspond to different functional areas. If the floor located by the terminal is determined, it is possible to know a scenario where a positioning is occurring, to determine needs of the terminal. For example, when it is determined that the floor located by the terminal is the 5^{th} floor and the 5^{th} floor is a dining area, an introduction of dining rooms can be pushed to the terminal.

Currently, the conventional indoor positioning manner needs to be based on the wireless network communication technology (Wi-Fi) fingerprint database. The construction of the Wi-Fi fingerprint database requires a collector to collect a Wi-Fi fingerprint of a current location indoors and mark current location information such as latitude, longitude, and altitude or floor for the Wi-Fi fingerprint. After that, the collector collects a Wi-Fi fingerprint of each indoor location every time he goes and marks the location of the Wi-Fi fingerprint. This way of constructing the Wi-Fi fingerprint database requires a lot of manual operations, thus the collection cost is high.

Moreover, due to a failure of an indoor Wi-Fi, it is necessary to manually re-collect the Wi-Fi fingerprint database at regular intervals, which requires a lot of time and human resources, resulting in the low efficiency in constructing the Wi-Fi fingerprint database.

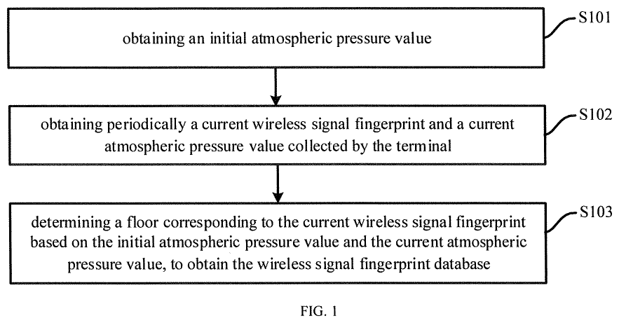

To improve the efficiency of constructing the Wi-Fi fingerprint database, some embodiments of the disclosure provide a method for generating a wireless signal fingerprint database. The method can be applied to an electronic device, in which the electronic device can be a terminal or a server. For example, a terminal can be a mobile phone, a tablet computer, or a device that can recognize wireless signals such as a smart bracelet. As shown in FIG. 1, the method includes the following steps.

S101, an initial atmospheric pressure value is obtained. The initial atmospheric pressure value is an atmospheric pressure value collected by a terminal when the terminal enters indoors.

Optionally, when the electronic device is the terminal, the terminal may immediately collect the current atmospheric pressure value as the initial atmospheric pressure value when entering an indoor from an outdoor.

When the electronic device is the server, the terminal can immediately collect the current atmospheric pressure value as the initial atmospheric pressure value when entering an indoor from an outdoor and send the initial atmospheric pressure value to the server. That is, the server can receive the initial atmospheric pressure value collected by the terminal.

S102, a current wireless signal fingerprint and a current atmospheric pressure value collected by the terminal, are obtained periodically.

In an implementation manner, when the electronic device is the terminal, after the terminal enters indoors, the current wireless signal fingerprint and the current atmospheric pressure value can be collected periodically. The current atmospheric pressure value can be measured by a barometer configured on the terminal.

When the electronic device is the server, the server may periodically obtain the current wireless signal fingerprint and the current atmospheric pressure value sent by the terminal after the terminal enters indoors.

For example, the current wireless signal fingerprint and the current atmospheric pressure value collected by the terminal can be obtained every second.

In technical solutions of the disclosure, collection, storage, usage, processing, transmission, provision, and disclosure of wireless signal fingerprints involved are all in compliance with relevant laws and regulations, and do not violate public order and good customs.

S103, a floor corresponding to the current wireless signal fingerprint is determined based on the initial atmospheric pressure value and the current atmospheric pressure value, to obtain the wireless signal fingerprint database.

According to laws of physics, the atmospheric pressure value decreases by 100 Pascals (Pa) for every 9 meters of altitude rise. Taking the electronic device as the mobile phone as an example, the unit of the atmospheric pressure value of the mobile phone is hectopascal. It is assumed that the indoor floor height is 3 meters, the atmospheric pressure value decreases by 0.33 units for each floor rise. Combining the above rules, the atmospheric pressure difference between the current atmospheric pressure value and the initial atmospheric pressure value can be divided by 0.33 to obtain the floor of the terminal relative to the ground, that is, the floor corresponding to the current wireless signal fingerprint.

Optionally, the region located by the terminal may be determined in combination with a satellite positioning before the terminal enters indoors, and the indoor floor height is determined according to the region located by the terminal. For example, when the region located by the terminal is a shopping mall, the floor height is determined to be 4.5 meters; and when the region located by the terminal is a residential region, the floor height is determined to be 2.8 meters.

With the method for generating a wireless signal fingerprint database provided in some embodiments of the disclosure, the initial atmospheric pressure value collected by the terminal when entering indoors is obtained, the current wireless signal fingerprint and current atmospheric pressure value collected by the terminal are obtained periodically, and based on the initial atmospheric pressure value and the current atmospheric pressure value, the floor corresponding to the current wireless signal fingerprint is determined, and the wireless signal fingerprint database is obtained. The embodiments of the disclosure automatically generate the wireless signal fingerprint database, thus improving the efficiency of constructing the wireless signal fingerprint database and reducing the consumption of human resources.

In some embodiments of the disclosure, the way of obtaining the initial atmospheric pressure value in S101 may be implemented as follows. A number of satellites connected to the terminal is monitored, and in response to the number of satellites connected to the terminal being less than a specified number, the current atmospheric pressure value is recorded as the initial atmospheric pressure value.

It is to be understood that the terminal can receive signals sent by multiple satellites when the satellite positioning is turned on. When the terminal enters indoors from outdoors, the number of satellites that the terminal can receive signals is reduced due to the obstruction of the building. When the number of satellites is less than the specified number, it can be considered that the terminal enters indoors.

The specified number can be preset according to the actual situation, for example, the specified number is 4.

Using the above manner, embodiments of the disclosure can determine whether the terminal enters indoors based on the number of satellites connected to the terminal. Since satellite signals are difficult to reach indoors, this manner can accurately determine whether the terminal has entered indoors. Therefore, when entering indoors, the current atmospheric pressure value is recorded in time, that is, the initial atmospheric pressure value of the indoor place is obtained.

In some embodiments of the disclosure, each wireless signal fingerprint includes one or more pieces of wireless signal information collected at the same location and each piece of wireless signal information includes Wi-Fi information or Bluetooth information. each piece of wireless signal information includes a media access control address (MAC) of a transmitting device, a signal strength, and a signal identifier. Each piece of wireless signal information corresponds to the same wireless signal.

The signal identifier may be a service set identifier (SSID) of the wireless signal and the SSID may be set by an owner of the wireless signal.

Taking the wireless signal fingerprint as the Wi-Fi fingerprint as an example, the Wi-Fi fingerprint is: aaaaaaa;-50;123|bbbbbbb;-50;234|cccccccc;-51;345|dddddddd;-51;456|eeeeeee;-53;567, where, aaaaaaa represents the MAC of the router, -50 represents the strength of the Wi-Fi signal transmitted by the aaaaaaa router which is collected at this location, and 123 represents the identifier of the Wi-Fi signal. Reference may be made to other information such as, eeeeeee represents the MAC address of the router, -53 represents the strength of the Wi-Fi signal transmitted by the eeeeeee router which is collected at this location, and 567 represents the identifier of the Wi-Fi signal.

In some embodiments, after obtaining the current wireless signal fingerprint in S102, the wireless signal information included in the wireless signal fingerprint may be screened, including the following. Semantic recognition is performed on SSID included in each piece of wireless signal information, so as to determine whether it is a signal from a fixed transmitting position. For example, semantic information corresponding to the SSID is recognized, to determine whether the wireless signal is deployed by the merchant. If it is deployed by the merchant, the wireless signal is the signal from the fixed transmission location, and the wireless signal information is retained. If it is not deployed by the merchant, that is, the wireless signal transmitted by a personal device, the transmission position of the wireless signal may move, so the wireless signal information is deleted.

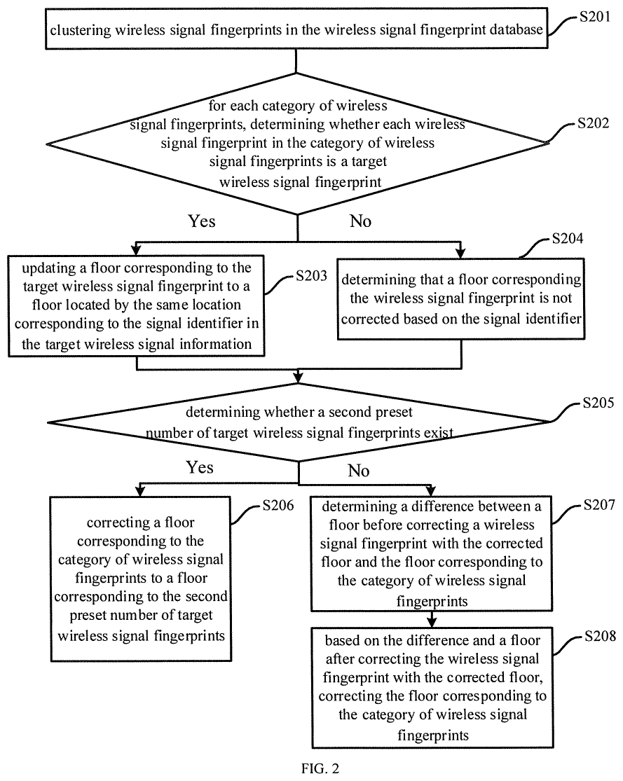

On this basis, after the wireless signal fingerprint database is obtained in S103, some embodiments of the disclosure can also correct the floor corresponding to the wireless signal fingerprint in the wireless signal database. As shown in FIG. 2, the correction manner includes the following steps.

S201, wireless signal fingerprints in the wireless signal fingerprint database are clustered.

In an implementation manner, since the floor corresponding to each wireless signal fingerprint has been determined when the wireless signal fingerprint database is constructed, the wireless signal fingerprints in the wireless signal fingerprint database can be clustered based on the floor corresponding to each wireless signal fingerprint. That is, the wireless signal fingerprints of the same floor are classified into one category.

In another implementation manner, a cosine similarity between each two wireless signal fingerprints in the wireless signal fingerprint database may be calculated based on wireless signal information included in the wireless signal fingerprints and atmospheric pressure values corresponding to the wireless signal fingerprints. Then, based on the cosine similarity between each two wireless signal fingerprints, the wireless signal fingerprints in the wireless signal fingerprint database are clustered.

That is, for each wireless signal fingerprint, a vector corresponding to this wireless signal fingerprint is constructed according to the wireless signal information included in this wireless signal fingerprint and the atmospheric pressure value corresponding to this wireless signal fingerprint. Then, the cosine similarity between each two vectors is calculated to obtain the similarity between the wireless signal fingerprints. Subsequently, based on the similarity between the wireless signal fingerprints, the wireless signal fingerprints may be clustered based on K-means (k-means) or other clustering algorithms.

Compared with the floor-based clustering manner, the wireless signal information and the corresponding atmospheric pressure value included in the wireless signal fingerprint can avoid errors when determining the floor, thus improving the clustering accuracy.

S202, for each category of wireless signal fingerprints, it is determined whether each wireless signal fingerprint in the category of wireless signal fingerprints is a target wireless signal fingerprint. If yes, S203 is performed; if not, S204 is performed to determine that a floor corresponding the wireless signal fingerprint is not corrected based on the signal identifier.

The target wireless signal fingerprint includes a first preset number of pieces of target wireless signal information with the signal strength exceeding a preset strength and the SSID corresponding to the same location. Both the preset strength and the first preset number can be set according to actual conditions, for example, the preset strength is -50 and the first preset number is 3.

In an implementation manner, for each wireless signal fingerprint, a piece of wireless signal information with the signal strength greater than the preset strength may be obtained from each piece of wireless signal information in the wireless signal fingerprint. A pre-established access point (AP)-point of interest (POI) mapping library is obtained, where the AP-POI mapping library includes correspondences between multiple SSIDs and shops. The shop corresponding to the SSID in the wireless signal information is determined according to the AP-POI mapping library. If there are the same shops less than the first preset number among these shops, it is determined that the wireless signal information of the SSID corresponding to the same shop belongs to the target wireless signal information, and the wireless signal fingerprint is the target wireless signal fingerprint.

The corresponding relationship between the SSID and the shop can be obtained by performing semantic recognition on the SSID, and matching the shop corresponding to the SSID based on the semantic recognition result. Alternatively, it may also be determined in other ways, for example, manually setting the shop corresponding to the SSID, which is not specifically limited in some embodiments of the disclosure.

Taking the wireless signal fingerprint as the Wi-Fi fingerprint as an example, a Wi-Fi fingerprint is: aaaaaaa;-50;123|bbbbbbb;-50;234|cccccccc;-51;345|dddddddd;-51;456|eeeeeee;-53;567.

It is assumed that the preset strength is -53, the signal strength of the first four pieces of Wi-Fi information of the Wi-Fi fingerprint is all greater than -53. It is assumed that 123, 123 and 345 correspond to XX shop, and 456 corresponds to YY shop. When the first preset number is 3, the first third pieces of Wi-Fi information of the Wi-Fi fingerprint can be determined as the target Wi-Fi information, and the Wi-Fi fingerprint can be determined as the target Wi-Fi fingerprint.

S203, a floor corresponding to the target wireless signal fingerprint is updated to a floor located by the same location corresponding to the signal identifier in the target wireless signal information.

In an implementation manner, the floor corresponding to the target wireless signal fingerprint may be updated to the floor corresponding to the position corresponding to the SSID in the target wireless signal information according to the pre-recorded floor of each position.

For example, in the target wireless signal fingerprint, the SSID in the target wireless signal information corresponds to the XX shop. According to the pre-recorded XX shop in the POI address database being floor 2, the floor corresponding to the target wireless signal fingerprint is updated to floor 2.

S205, it is determined whether a second preset number of target wireless signal fingerprints with the same floor after updating exist in the category of wireless signal fingerprints. If it exists, S206 is executed.

The second preset number can be set according to the actual situation. For example, the second preset number is 3.

S206, a floor corresponding to the category of wireless signal fingerprints is corrected to a floor corresponding to the second preset number of target wireless signal fingerprints.

Combining S205 and S206 as an example, taking the wireless signal fingerprint as the Wi-Fi fingerprint as an example. It is assumed that the second preset number is 2. One category of Wi-Fi fingerprints includes: Wi-Fi fingerprint 1 corresponds to floor 2, Wi-Fi fingerprint 2 corresponds to floor 2, Wi-Fi fingerprint 3 corresponds to floor 1, Wi-Fi fingerprint 4 corresponds to floor 2, Wi-Fi fingerprint 5 corresponds to floor 2, and Wi-Fi fingerprint 6 corresponds to floor 2. It is assumed that the target Wi-Fi fingerprints include Wi-Fi fingerprints 1-4, and three of the Wi-Fi fingerprints 1-4 correspond to floor 2, so the floors corresponding to these Wi-Fi fingerprints are corrected to floor 2.

By using the above method, some embodiments of the disclosure can correct the floor corresponding to the wireless signal fingerprint based on the floor where the known shop is located, thereby improving the accuracy of determining the floor where the wireless signal fingerprint is located.

In some embodiments of the disclosure, as shown in FIG. 2, after determining whether the second preset number of target wireless signal fingerprints with the same floor after updating exist in the category of wireless signal fingerprints, if not, the disclosure implements the following steps.

S207, a difference between a floor before correcting a wireless signal fingerprint with the corrected floor and the floor corresponding to the category of wireless signal fingerprints is determined.

The wireless signal fingerprint with the corrected floor is the wireless signal fingerprint of correcting the floor through S206.

S208, based on the difference and a floor after correcting the wireless signal fingerprint with the corrected floor, the floor corresponding to the category of wireless signal fingerprints is corrected.

Combining S207 and S208 as an example, one category of wireless signal fingerprints A has not been corrected, and the corresponding floor is floor 6. It is assumed that a category of wireless signal fingerprints B corresponds to floor 5 before correction, and the corresponding floor after correction is floor 6, and the difference between the wireless signal fingerprint B and the wireless signal fingerprint A before correction is 1, so the floor corresponding to the wireless signal fingerprint A should be corrected to floor 7.

Using the above method, even if one category of wireless signal fingerprints may not be corrected by the floor corresponding to the SSID, it can be corrected by the floor corresponding to the corrected wireless signal fingerprint, so as to achieve the effect of correcting various wireless signal fingerprints in the wireless signal fingerprint database.

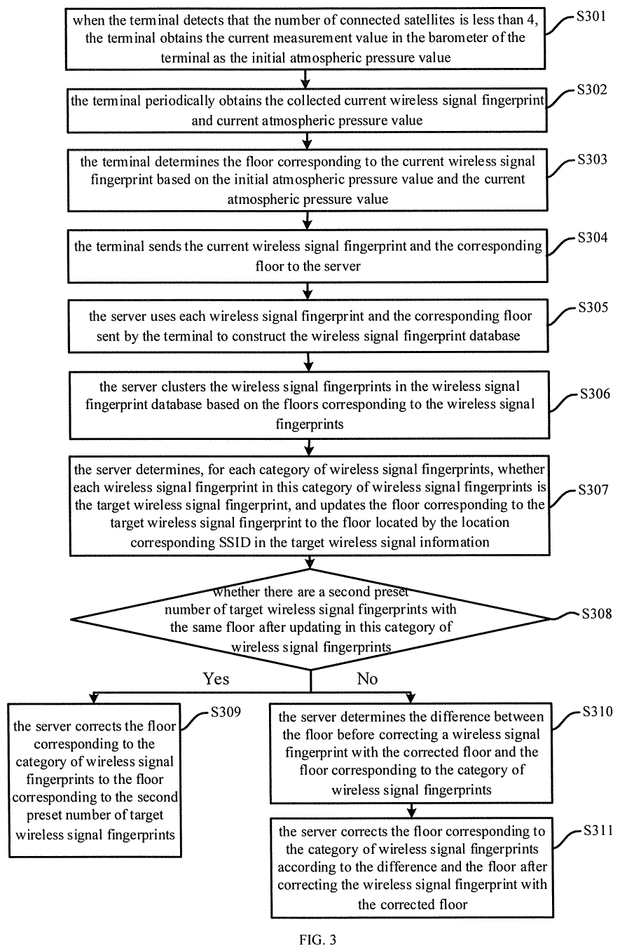

Referring to FIG. 3, the following describes the overall process of the method for generating a wireless signal fingerprint database provided in some embodiments of the disclosure in combination with specific application scenarios.

S301, when the terminal detects that the number of connected satellites is less than 4, the terminal obtains the current measurement value in the barometer of the terminal as the initial atmospheric pressure value.

S302, the terminal periodically obtains the collected current wireless signal fingerprint and current atmospheric pressure value.

S303, the terminal determines the floor corresponding to the current wireless signal fingerprint based on the initial atmospheric pressure value and the current atmospheric pressure value.

S304, the terminal sends the current wireless signal fingerprint and the corresponding floor to the server.

S305, the server uses each wireless signal fingerprint and the corresponding floor sent by the terminal to construct the wireless signal fingerprint database.

S306, the server clusters the wireless signal fingerprints in the wireless signal fingerprint database based on the floors corresponding to the wireless signal fingerprints.

S307, the server determines, for each category of wireless signal fingerprints, whether each wireless signal fingerprint in this category of wireless signal fingerprints is the target wireless signal fingerprint, and updates the floor corresponding to the target wireless signal fingerprint to the floor located by the location corresponding SSID in the target wireless signal information.

S308, the server determines whether there are a second preset number of target wireless signal fingerprints with the same floor after updating in this category of wireless signal fingerprints. If it exists, S309 is executed; if not, S310 is executed.

S309, the server corrects the floor corresponding to the category of wireless signal fingerprints to the floor corresponding to the second preset number of target wireless signal fingerprints.

S310, the server determines the difference between the floor before correcting a wireless signal fingerprint with the corrected floor and the floor corresponding to the category of wireless signal fingerprints.

S311, the server corrects the floor corresponding to the category of wireless signal fingerprints according to the difference and the floor after correcting the wireless signal fingerprint with the corrected floor.

Since many mobile terminals keep the satellite positioning and network connection turned on, these terminals can continuously collect wireless signal fingerprints during the moving process, determine the floors and atmospheric pressure values corresponding to the wireless signal fingerprints through the above method, and report them to the server. That is, the server can obtain wireless signal fingerprints and atmospheric pressure values through crowdsourcing, so as to build the wireless signal fingerprint database with low cost.

After the wireless signal fingerprint database is constructed, the server may receive the positioning request sent by the terminal, in which the positioning request includes the wireless signal fingerprint collected at the current location of the terminal. The server calculates the cosine similarity between the wireless signal fingerprint carried in the positioning request and the wireless signal fingerprint in the wireless signal fingerprint database, and obtains the floor corresponding to the wireless signal fingerprint with the highest cosine similarity in the wireless signal fingerprint database. After that, the server returns the determined floor to the terminal, thereby realizing the indoor positioning.

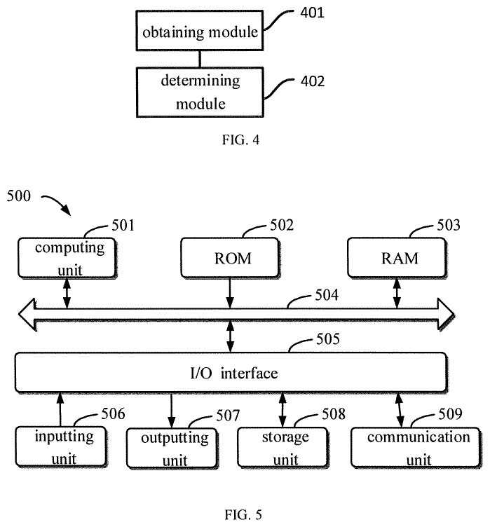

Based on the same concept and corresponding to the above method embodiments, embodiments of the disclosure provide an apparatus for generating a wireless signal fingerprint database. As shown in FIG. 4, the apparatus includes an obtaining module 401 and a determining module 402.

The obtaining module 401 is configured to obtain an initial atmospheric pressure value, in which the initial atmospheric pressure value is an atmospheric pressure value collected when a terminal enters indoors, and obtain periodically a current wireless signal fingerprint and a current atmospheric pressure value collected by the terminal.

The determining module 402 is configured to determine a floor corresponding to the current wireless signal fingerprint based on the initial atmospheric pressure value and the current atmospheric pressure value, to obtain the wireless signal fingerprint database.

With the apparatus for generating a wireless signal fingerprint database provided in some embodiments of the disclosure, the initial atmospheric pressure value collected by the terminal when entering indoors is obtained, the current wireless signal fingerprint and current atmospheric pressure value collected by the terminal are obtained periodically, and based on the initial atmospheric pressure value and the current atmospheric pressure value, the floor corresponding to the current wireless signal fingerprint is determined, and the wireless signal fingerprint database is obtained. The embodiments of the disclosure automatically generate the wireless signal fingerprint database, thus improving the efficiency of constructing the wireless signal fingerprint database and reducing the consumption of human resources.

In some embodiments of the disclosure, the obtaining module 401 is configured to: monitor a number of satellites connected to the terminal; and in response to the number of satellites connected to the terminal being less than a specified number, record the current atmospheric pressure value as the initial atmospheric pressure value.

In some embodiments of the disclosure, each wireless signal fingerprint includes one or more pieces of wireless signal information collected at the same location, each piece of wireless signal information includes a media access control address of a transmitting device, a signal strength, and a signal identifier, and the apparatus may further include: a clustering module, configured to cluster wireless signal fingerprints in the wireless signal fingerprint database; a judging module, configured to, for each category of wireless signal fingerprints, determine whether each wireless signal fingerprint in the category of wireless signal fingerprints is a target wireless signal fingerprint, in which the target wireless signal fingerprint includes a first preset number of pieces of target wireless signal information with the signal strength exceeding a preset strength and the signal identifier corresponding to the same location; an updating module, configured to, in response to each wireless signal fingerprint in the category of wireless signal fingerprints is the target wireless signal fingerprint, update a floor corresponding to the target wireless signal fingerprint to a floor located by the same location corresponding to the signal identifier in the target wireless signal information; the judging module being configured to determine whether a second preset number of target wireless signal fingerprints with the same floor after updating exist in the category of wireless signal fingerprints; and a correcting module, configured to, in response to the second preset number of target wireless signal fingerprints with the same floor after updating existing in the category of wireless signal fingerprints, correct a floor corresponding to the category of wireless signal fingerprints to a floor corresponding to the second preset number of target wireless signal fingerprints.

In some embodiments of the disclosure, the determining module 402 is further configured to in response to the second preset number of target wireless signal fingerprints with the same floor after updating not existing in the category of wireless signal fingerprints, determine a difference between a floor before correcting a wireless signal fingerprint with the corrected floor and the floor corresponding to the category of wireless signal fingerprints; and the correcting module is further configured to, based on the difference and a floor after correcting the wireless signal fingerprint with the corrected floor, correct the floor corresponding to the category of wireless signal fingerprints.

In some embodiments of the disclosure, the clustering module is configured to: calculate a cosine similarity between every two wireless signal fingerprints in the wireless signal fingerprint database based on wireless signal information in the wireless signal fingerprints and atmospheric pressure values corresponding to the wireless signal fingerprints; and cluster the wireless signal fingerprints in the wireless signal fingerprint database based on the cosine similarity between every two wireless signal fingerprints.

According to embodiments of the disclosure, the disclosure also provides an electronic device, a readable storage medium, and a computer program product.

FIG. 5 is a block diagram of an example electronic device 500 according to embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 5, the device 500 includes a computing unit 501 performing various appropriate actions and processes based on computer programs stored in a read-only memory (ROM) 502 or computer programs loaded from the storage unit 508 to a random-access memory (RAM) 503. In the RAM 503, various programs and data required for the operation of the device 500 are stored. The computing unit 501, the ROM 502, and the RAM 503 are connected to each other through a bus 504. An input/output (I/O) interface 505 is also connected to the bus 504.

Components in the device 500 are connected to the I/O interface 505, including: an inputting unit 506, such as a keyboard, a mouse; an outputting unit 507, such as various types of displays, speakers; a storage unit 508, such as a disk, an optical disk; and a communication unit 509, such as network cards, modems, and wireless communication transceivers. The communication unit 509 allows the device 500 to exchange information/data with other devices through a computer network such as the Internet and/or various telecommunication networks.

The computing unit 501 may be various general-purpose and/or dedicated processing components with processing and computing capabilities. Some examples of computing unit 501 include, but are not limited to, a central processing unit (CPU), a graphics processing unit (GPU), various dedicated Al computing chips, various computing units that run machine learning model algorithms, and a digital signal processor (DSP), and any appropriate processor, controller and microcontroller. The computing unit 501 executes the various methods and processes described above, such as the above method. For example, in some embodiments, the above method may be implemented as a computer software program, which is tangibly contained in a machine-readable medium, such as the storage unit 508. In some embodiments, part or all of the computer program may be loaded and/or installed on the device 500 via the ROM 502 and/or the communication unit 509. When the computer program is loaded on the RAM 503 and executed by the computing unit 501, one or more steps of the method described above may be executed. Alternatively, in other embodiments, the computing unit 501 may be configured to perform the method in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), the Internet and the block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host, which is a host product in the cloud computing service system, to solve the defects of difficult management and weak business scalability in the traditional physical host and virtual private server (VPS) service. The server can also be a server of distributed system or a server combined with block-chain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

1. A method for generating a wireless signal fingerprint database, comprising:
obtaining an initial atmospheric pressure value, wherein the initial atmospheric pressure value is an atmospheric pressure value collected when a terminal enters indoors;
obtaining periodically a current wireless signal fingerprint and a current atmospheric pressure value collected by the terminal; and
determining a floor corresponding to the current wireless signal fingerprint based on the initial atmospheric pressure value and the current atmospheric pressure value, to obtain the wireless signal fingerprint database.

2. The method of claim 1, wherein obtaining the initial atmospheric pressure value comprises:
monitoring a number of satellites connected to the terminal; and
in response to the number of satellites connected to the terminal being less than a specified number, recording the current atmospheric pressure value as the initial atmospheric pressure value.

3. The method of claim 1, wherein each wireless signal fingerprint comprises one or more pieces of wireless signal information collected at the same location, each piece of wireless signal information comprises a media access control address of a transmitting device, a signal strength, and a signal identifier, and the method further comprises:
clustering wireless signal fingerprints in the wireless signal fingerprint database;
for each category of wireless signal fingerprints, determining whether each wireless signal fingerprint in the category of wireless signal fingerprints is a target wireless signal fingerprint, wherein the target wireless signal fingerprint comprises a first preset number of pieces of target wireless signal information with the signal strength exceeding a preset strength and the signal identifier corresponding to the same location;
in response to each wireless signal fingerprint in the category of wireless signal fingerprints is the target wireless signal fingerprint, updating a floor corresponding to the target wireless signal fingerprint to a floor located by the same location corresponding to the signal identifier in the target wireless signal information;
determining whether a second preset number of target wireless signal fingerprints with the same floor after updating exist in the category of wireless signal fingerprints; and
in response to the second preset number of target wireless signal fingerprints with the same floor after updating existing in the category of wireless signal fingerprints, correcting a floor corresponding to the category of wireless signal fingerprints to a floor corresponding to the second preset number of target wireless signal fingerprints.

4. The method of claim 3, further comprising:
in response to the second preset number of target wireless signal fingerprints with the same floor after updating not existing in the category of wireless signal fingerprints, determining a difference between a floor before correcting a wireless signal fingerprint with the corrected floor and the floor corresponding to the category of wireless signal fingerprints; and
based on the difference and a floor after correcting the wireless signal fingerprint with the corrected floor, correcting the floor corresponding to the category of wireless signal fingerprints.

5. The method of claim 3, wherein clustering the wireless signal fingerprints in the wireless signal fingerprint database comprises:
calculating a cosine similarity between every two wireless signal fingerprints in the wireless signal fingerprint database based on wireless signal information in the wireless signal fingerprints and atmospheric pressure values corresponding to the wireless signal fingerprints; and
clustering the wireless signal fingerprints in the wireless signal fingerprint database based on the cosine similarity between every two wireless signal fingerprints.

6. An electronic device comprising:
a processor; and
a memory communicatively coupled to the processor;
wherein, the memory is configured to store instructions executable by the processor, and the processor is configured to execute the instructions to:
obtain an initial atmospheric pressure value, wherein the initial atmospheric pressure value is an atmospheric pressure value collected when a terminal enters indoors;
obtain periodically a current wireless signal fingerprint and a current atmospheric pressure value collected by the terminal; and
determine a floor corresponding to the current wireless signal fingerprint based on the initial atmospheric pressure value and the current atmospheric pressure value, to obtain the wireless signal fingerprint database.

7. The device of claim 6, wherein the processor is configured to execute the instructions to:
monitor a number of satellites connected to the terminal; and
in response to the number of satellites connected to the terminal being less than a specified number, record the current atmospheric pressure value as the initial atmospheric pressure value.

8. The device of claim 6, wherein each wireless signal fingerprint comprises one or more pieces of wireless signal information collected at the same location, each piece of wireless signal information comprises a media access control address of a transmitting device, a signal strength, and a signal identifier, and the processor is configured to execute the instructions to:
cluster wireless signal fingerprints in the wireless signal fingerprint database;
for each category of wireless signal fingerprints, determine whether each wireless signal fingerprint in the category of wireless signal fingerprints is a target wireless signal fingerprint, wherein the target wireless signal fingerprint comprises a first preset number of pieces of target wireless signal information with the signal strength exceeding a preset strength and the signal identifier corresponding to the same location;
in response to each wireless signal fingerprint in the category of wireless signal fingerprints is the target wireless signal fingerprint, update a floor corresponding to the target wireless signal fingerprint to a floor located by the same location corresponding to the signal identifier in the target wireless signal information;
determine whether a second preset number of target wireless signal fingerprints with the same floor after updating exist in the category of wireless signal fingerprints; and
in response to the second preset number of target wireless signal fingerprints with the same floor after updating existing in the category of wireless signal fingerprints, correct a floor corresponding to the category of wireless signal fingerprints to a floor corresponding to the second preset number of target wireless signal fingerprints.

9. The device of claim 8, wherein the processor is configured to execute the instructions to:
in response to the second preset number of target wireless signal fingerprints with the same floor after updating not existing in the category of wireless signal fingerprints, determine a difference between a floor before correcting a wireless signal fingerprint with the corrected floor and the floor corresponding to the category of wireless signal fingerprints; and
based on the difference and a floor after correcting the wireless signal fingerprint with the corrected floor, correct the floor corresponding to the category of wireless signal fingerprints.

10. The device of claim 8, wherein the processor is configured to execute the instructions to:
calculate a cosine similarity between every two wireless signal fingerprints in the wireless signal fingerprint database based on wireless signal information in the wireless signal fingerprints and atmospheric pressure values corresponding to the wireless signal fingerprints; and
cluster the wireless signal fingerprints in the wireless signal fingerprint database based on the cosine similarity between every two wireless signal fingerprints.

11. A non-transitory computer-readable storage medium having stored therein instructions that, when executed by a processor of a device, causes the device to perform a method for generating a wireless signal fingerprint database, the method comprising:
obtaining an initial atmospheric pressure value, wherein the initial atmospheric pressure value is an atmospheric pressure value collected when a terminal enters indoors;
obtaining periodically a current wireless signal fingerprint and a current atmospheric pressure value collected by the terminal; and
determining a floor corresponding to the current wireless signal fingerprint based on the initial atmospheric pressure value and the current atmospheric pressure value, to obtain the wireless signal fingerprint database.

12. The non-transitory computer-readable storage medium of claim 11, wherein obtaining the initial atmospheric pressure value comprises:
monitoring a number of satellites connected to the terminal; and
in response to the number of satellites connected to the terminal being less than a specified number, recording the current atmospheric pressure value as the initial atmospheric pressure value.

13. The non-transitory computer-readable storage medium of claim 11, wherein each wireless signal fingerprint comprises one or more pieces of wireless signal information collected at the same location, each piece of wireless signal information comprises a media access control address of a transmitting device, a signal strength, and a signal identifier, and the method further comprises:
clustering wireless signal fingerprints in the wireless signal fingerprint database;
for each category of wireless signal fingerprints, determining whether each wireless signal fingerprint in the category of wireless signal fingerprints is a target wireless signal fingerprint, wherein the target wireless signal fingerprint comprises a first preset number of pieces of target wireless signal information with the signal strength exceeding a preset strength and the signal identifier corresponding to the same location;
in response to each wireless signal fingerprint in the category of wireless signal fingerprints is the target wireless signal fingerprint, updating a floor corresponding to the target wireless signal fingerprint to a floor located by the same location corresponding to the signal identifier in the target wireless signal information;
determining whether a second preset number of target wireless signal fingerprints with the same floor after updating exist in the category of wireless signal fingerprints; and
in response to the second preset number of target wireless signal fingerprints with the same floor after updating existing in the category of wireless signal fingerprints, correcting a floor corresponding to the category of wireless signal fingerprints to a floor corresponding to the second preset number of target wireless signal fingerprints.

14. The non-transitory computer-readable storage medium of claim 13, wherein the method further comprises:
in response to the second preset number of target wireless signal fingerprints with the same floor after updating not existing in the category of wireless signal fingerprints, determining a difference between a floor before correcting a wireless signal fingerprint with the corrected floor and the floor corresponding to the category of wireless signal fingerprints; and
based on the difference and a floor after correcting the wireless signal fingerprint with the corrected floor, correcting the floor corresponding to the category of wireless signal fingerprints.

15. The non-transitory computer-readable storage medium of claim 13, wherein clustering the wireless signal fingerprints in the wireless signal fingerprint database comprises:
calculating a cosine similarity between every two wireless signal fingerprints in the wireless signal fingerprint database based on wireless signal information in the wireless signal fingerprints and atmospheric pressure values corresponding to the wireless signal fingerprints; and
clustering the wireless signal fingerprints in the wireless signal fingerprint database based on the cosine similarity between every two wireless signal fingerprints.
